(19) United States
(12) Patent Application Publication
(10) Pub. No.: US 2008/0008419 A1
(43) Pub. Date: Jan. 10, 2008

(54) Fibre-Lens Arrangement and Lens Array for One Such Fibre-Lens Arrangement

(75) Inventors: Roger Krahenbuhl, Herisau (CH); Patrick Zaina, Wil (CH); Jens Kunde, Alpnach Dorf (CH)

Correspondence Address: THE WEBB LAW FIRM, P.C., 700 KOPPERS BUILDING, 436 SEVENTH AVENUE, PITTSBURGH, PA, 15219, US

(73) Assignee: HuberAG, Herisau (CH)

(21) Appl. No.: 11/666,770

(22) PCT Filed: Aug. 17, 2005
(86) PCT No.: PCT/CH05/00475

§ 371 Date: May 2, 2007

(30) Foreign Application Priority Data
Nov. 3, 2004 (CH) 1816/04

(51) Int. Cl. G02B 6/32

(52) U.S. Cl. 385/33

(57) ABSTRACT

The invention relates to a fiber-lens arrangement having a fiber array with a substrate provided with a plurality of adjacent, interspaced, parallel, homogeneous V-shaped grooves for receiving and orienting the end sections of a plurality of optical fibers, and a separate lens array which matches the fiber array. The fiber array has, in a common base body, a number of lenses corresponding to the number of optical fibers. The arrangement of said lenses in the base body corresponds to the arrangement of the optical fibers in the V-shaped grooves of the fiber array on the substrate. One such fiber-lens arrangement enables a simple, precise and flexible adjustment to be carried out, using a separate adjusting mechanism for the optical orientation of the lens array on the fiber array, said adjusting means co-operating with the V-shaped grooves of the fiber array.

### TECHNICAL FIELD

The present invention relates to the field of fiber optic signal transmission. It concerns a fiber-lens arrangement in accordance with the preamble of claim 1, and a lens array for such a fiber-lens arrangement.

### PRIOR ART

When arrangements of a plurality of parallel optical fibers (“Fiber Arrays”) are to be interconnected or to be coupled to active optical components (photodiodes, phototransistors, VCSELs or the like), it is customary to use appropriate lens arrays in which there are present a number, corresponding to the number of fibers, of optical lenses of which each is assigned to a fiber.

Publication US-A1-2002/0196998 describes an optical arrangement for coupling to integrated optical devices, in the case of which an array of optical fibers is coupled via an imaging device to an optical waveguide with a corresponding number of parallel waveguide cores. The optical waveguide is connected in this case to a substrate that has a plurality of V-shaped grooves for holding and positioning the fibers of the array. A depression for holding the imaging device is provided in the substrate between the V-shaped grooves and the optical waveguide. The imaging device comprises a corresponding number of GRIN (GRadient INdex) lenses. It is positioned in the depression with reference to the fibers and the optical waveguide by being displaced in a number of spatial directions and then bonded (FIGS. 1-4 of the publication). The imaging device can, however, also alternatively comprise spherical lenses (FIG. 16 of the publication) that are seated in the depressions and can then be position in height relative to the fibers. However, implementing the construction and accurate adjustment of this known optical arrangement is complex and comparatively difficult, especially as no specific adjusting aids are provided.

US-A1-2002/0031301 discloses an optical fiber-lens arrangement that produces a connection between GRIN rod lenses and a fiber groove array. The publication assumes a prior art (FIGS. 9 and 10 of the publication) in which a fiber and the associated GRIN lens are respectively brought together in a common sleeve (FIG. 9 of the application) or are aligned with one another by means of two abutting V-shaped grooves of different size (FIG. 10 of the publication; see also JP-A2-59036214 or JP-A2-08075950). The first case results in complex preassembly of fiber ends, while in the second case there is a problem of producing the substrate with high-precision V-grooves of different depth. By contrast with this prior art, US-A1-2002/0031301 proposes a solution (FIGS. 1, 4 of the application) in which use is made for the GRIN rod lenses of a second separate substrate that is aligned with reference to the fiber-guiding first substrate by means of additional guide pins. In one case (FIG. 1), it is necessary for three different types of V-grooves (for the fibers, for the lenses and for the guide pins) of different depth to be produced in two different substrates, and this is exceptionally problematic with reference to the accuracy of adjustment. In another case (FIG. 4), there is a need for three different types of centrifugal bores instead of V-grooves, and this leads to the same problems for the accuracy of adjustment.

Furthermore, it is known from JP-A-2004109498 (FIGS. 1-3) to adjust the fiber groove array, provided with V-grooves, and a microlens array to one another in such a way that there are provided on the underside of the microlens array bulges (5) that project outward concentrically relative to the optical axes of the respective lenses and are provided in the form of annular segments with the aid of which the microlens array is inserted into the V-grooves of the fiber groove array.

However, this solution has a number of disadvantages: since the adjusting bulges surround the lenses concentrically, the outside diameter of the lenses must be substantially smaller than the outside diameter of the fibers of the fiber groove array. This greatly limits the freedom in fashioning the lenses. Furthermore, there is one adjusting bulge present for each of the lenses. Given more than two lenses, this means that overdetermination of the adjustment can lead to adjusting errors for individual lenses. Finally, it is possible to produce the bulges with the requisite precision only with great difficulty and a large outlay.

The overdetermination of the adjustment also results for the solution disclosed in JP-A-8075950 in which all lenses of the lens array are used for the adjustment. In this case, relatively large lens diameters require deepened V-groove sections at the inlet, and so V-grooves of different depth have to be produced, thus impairing the accuracy of adjustment.

### SUMMARY OF THE INVENTION

It is therefore an object of the invention to provide an adjustable optical fiber-lens arrangement with a fiber groove array and a lens array which avoids the disadvantages of known arrangements and is distinguished in conjunction with a comparatively simple construction and simplified production by a consistently high accuracy of adjustment of the lenses relative to the fibers, as well as to specify a lens array suitable therefor.

The object is achieved by means of the totality of the features of claims 1 and 13. The core of the invention consists in using the lens array that has for the purpose of optical alignment with the fiber groove array separate adjusting means that cooperate with the V-grooves, provided for the optical fibers, on the fiber groove array. The use of the V-grooves, referred to the fibers, of the fiber groove array for the adjustment avoids the need to produce specific V-grooves for the adjustment that differ in shape and depth, and this leads to a simplification of production and to avoidance of errors in terms of accuracy that are due to process engineering. The separate adjusting means on the lens array ensure in this case that the lenses of the lens array are free from restrictions with regard to their configuration, and that it is possible to avoid an overdetermination in the adjustment.

The adjusting means are preferably arranged on the base body of the lens array. In this way, they do not intervene in the production of the fiber groove array and can be taken into account relatively easily in the production of the lens array.

When the lenses of the lens array are arranged in a linear row next to one another, it is particularly advantageous that the adjusting means are arranged outside and in the continuation of the row of lenses, specifically on both sides of the row of lenses. Owing to the adjusting means lying beyond the row of lenses and thus lying far apart from one another, the accuracy of adjustment is improved while at the same time an overdetermination is avoided in the adjustment.

One possible particular refinement of the adjusting means is characterized in that the adjusting means comprise outwardly projecting, cylindrical adjusting knobs that are integrally formed on the base body and with the aid of which the lens array is inserted into selected V-grooves of the fiber groove array in order to adjust with reference to the fiber groove array, the adjusting knobs preferably having the same outside diameter as the optical fibers. When the positions of the adjusting knobs on the base body are then adapted to the periodic pattern of the lenses, which is governed by the periodic pattern of the V-grooves on the fiber groove array, automatic adjustment results when the lens array with the adjusting knobs is inserted into corresponding V-grooves. Given the production of the lens array from glass or another optically transparent material, the adjusting knobs can, for example, be prepared by means of material-removing techniques such as grinding or etching, as also used in producing the lens array.

Another possible refinement of the adjusting means is characterized in that the adjusting means comprise outwardly projecting adjusting fiber sections or adjusting wire sections which have been inserted into the base body and with the aid of which the lens array is inserted into selected V-grooves of the fiber groove array in order to adjust with reference to the fiber groove array, the adjusting fiber sections or adjusting wire sections preferably projecting outward on opposite sides of the base body, and having the same outside diameter as the optical fibers. Because of the projection of the adjusting fiber sections on both sides, the V-grooves of the fiber groove array can be used for the adjustment on both sides of the transverse groove—when the fiber groove array has a transverse groove running transversely to the V-grooves that holds the lens array, and at least some of the V-grooves run on both sides of the transverse groove. Since the adjusting fiber sections or adjusting wire sections are plugged as independent elements into a bore, provided therefor, in the base body, when producing the lens array the forming of the adjusting means is reduced to the simpler introduction of bores into the base body.

However, it is also conceivable that instead of the pin-type adjusting means, provision is made of adjusting lenses and/or adjusting marks that are attached to or integrally formed on the base body and with the aid of which the lens array is mechanically and/or optically aligned with selected V-grooves of the fiber groove array in order to adjust with reference to the fiber groove array.

When a transverse groove for holding the lens array is provided on the fiber groove array, and the transverse groove is bounded on the longitudinal sides by vertical sidewalls, it has proved to be advantageous for the adjustment that the lens array with the base body bears against one of the sidewalls of the transverse groove.

A further preferred refinement of the lens array is characterized in that the devices for deflecting the light beams through the lenses are provided on the base body, in which case, in particular, the base body is made from an optically transparent material, in particular a glass, and in that the deflecting device is a reflecting surface formed on the base body (16). In addition to the lens action, it is thereby possible in a simple and space saving way to carry out a change in direction of the light beams, for example a 90° deflection, simultaneously with the aid of the lens array.

The fiber-lens arrangement according to the invention is preferably applied in a deflecting arrangement in which light from a first fiber groove array is deflected by a deflection element into a second fiber groove array.

Likewise preferred is the application of the fiber-lens arrangement according to the invention in a switchover arrangement in which light is optionally switched over via a switchover device from fibers of a first fiber groove array into fibers of a second fiber groove array.

A further application of the fiber-lens arrangement according to the invention relates to optically coupling fibers of a fiber groove array to active optical components.

### BRIEF DESCRIPTION OF THE FIGURES

The invention is to be explained in more detail below with the aid of exemplary embodiments in conjunction with the drawing, in which:

FIG. 1 shows a perspective side view of a fiber groove array as used in the preferred exemplary embodiment of the invention in accordance with FIG. 3;

FIG. 2 shows a preferred exemplary embodiment of a lens array according to the invention, with integrally formed adjusting knobs on both sides of the row of lenses;

FIG. 3 shows the fiber groove array from FIG. 1 with a lens array according to FIG. 5;

FIG. 4 shows, in an illustration comparable to FIG. 2, a further preferred exemplary embodiment of a lens array according to the invention with attached adjusting fiber sections or adjusting wire sections on both sides of the row of lenses;

FIG. 5 shows another preferred exemplary embodiment of a lens array according to the invention with integrally formed adjusting lenses on both sides of the row of lenses;

FIG. 6 shows an enlarged detail of the optical/mechanical adjustment of a lens array, equipped with the adjusting lenses and/or adjusting marks, in the fiber groove array in accordance with a further exemplary embodiment of the invention;

FIG. 7 shows a 90° deflecting arrangement with two fiber-lens arrangements according to the invention;

FIG. 8 shows a controllable switchover arrangement with two fiber-lens arrangements according to the invention;

FIG. 9 shows a partially sectioned illustration of the coupling of a fiber-lens arrangement according to the invention to active optical components with external 90° deflection;

FIG. 10 shows a partially sectioned illustration of the coupling of a fiber-lens arrangement according to the invention to active optical components with internal 90° deflection.

### WAYS OF IMPLEMENTING THE INVENTION

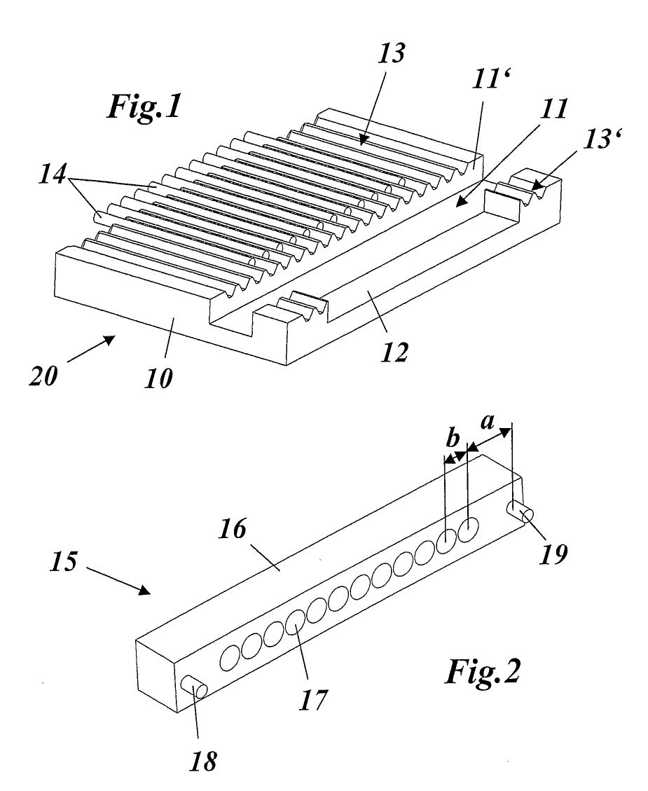

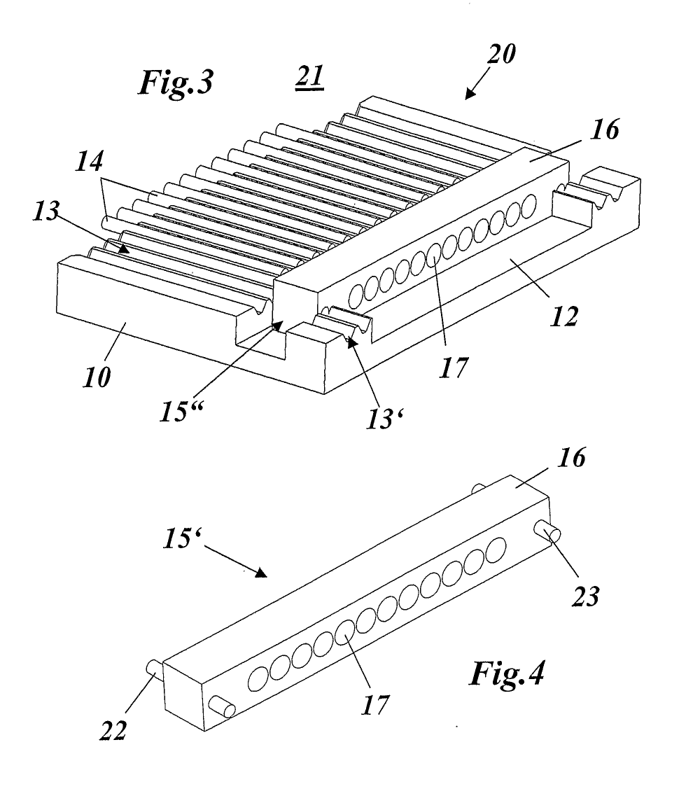

FIG. 1 illustrates a perspective side view of a fiber groove array as used in a preferred exemplary embodiment of the invention in accordance with FIG. 3. The fiber groove array 20 of FIG. 1 comprises a, for example, plate-shaped substrate 10 in whose surface a multiplicity of similar, parallel running V-grooves 13, 13′ are introduced. When the substrate 10 is, for example, produced from monocrystalline silicon, the V-grooves can be produced in the case of a specific crystal orientation of the substrate by means of an etching process such as is described, for example, in U.S. Pat. No. 5,217,568. The V grooves 13, 13′ hold the end sections of a multiplicity of optical fibers 14 which together form an array and by means of which the V-grooves are exactly aligned. The optical fibers can in this case slide removably into the V-grooves 13, 13′ by means of a plugging operation inside a plug-in connector system. However, they can also be fixed in the V-grooves with the aid of adhesive or the like. The diverging light emerging from the ends of the fibers 14 is analyzed or focused for the purpose of being further guided or processed by means of lenses arranged downstream of the fiber ends. Each of the optical fibers 14 is in this case assigned a dedicated lens, and these together form a lens array or microlens array as depicted at the reference numerals 15, 15′ and 15″ in FIGS. 2, 4 and 5. When the optical fibers 14 are designed as monomode fibers, the lenses of the lens array 15, 15′, 15″ must be adjusted to the fibers 14 firmly lying in the V-grooves with high accuracy with reference to the optical axes. Since the lenses 17 are fixed in position relative to one another inside the lens array 15, 15′, 15″ it is sufficient to adjust the entire lens array 15, 15′, 15″ with regard to the fibers 14.

In accordance with the present invention, for this purpose use is made on the side of the fiber groove array 20 or substrate 10 of the same V-grooves 13, 13′ in which the optical fibers 14 also lie. This has the advantage that the V-grooves for the fibers 14 and the V-grooves for adjusting the lens array 15, 15′, 15″ can be produced in the same process with high precision, and that deviations owing to different production processes are reliably avoided. Adjusting means that are independent of the lenses 17 and cooperate directly with the V-grooves of the fiber groove array 20 are used on the side of the lens array 15, 15′, 15″.

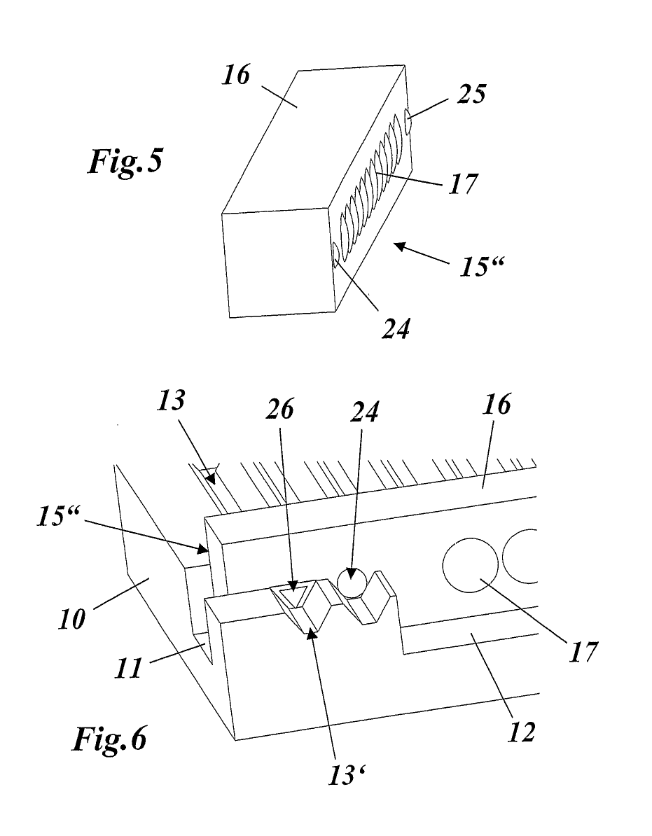

A first preferred refinement of the adjusting means on the lens array is reproduced in FIG. 2. The lens array 15 of FIG. 2 comprises a bar-shaped base body 16 of rectangular cross section. The base body 16 preferably consists of an optically transparent material, in particular a suitable glass. The lenses 17 are in this case produced in that in one lateral surface the surface of the base body 16 is respectively bulged outward locally in the manner of a lens surface (see also FIG. 5). Different types of lens arrays are conceivable, as disclosed, for example, in WO-A2-0216975 or in US-A1-2004/0130794 or in U.S. Pat. No. B1-6,515,800. However, it is also conceivable to use Fresnell lenses or GRIN lenses that are inserted into a nontransparent base body. The lenses 17 of the lens array 15 of FIG. 2 form a linear row with a periodic arrangement that corresponds to the periodic arrangement of the fibers 14 in the V-grooves 13, 13′. Provided outside the row of lenses at both ends as adjusting means are two cylindrical adjusting knobs 18, 19 which are oriented with their cylinder axis parallel to the optical axes of the lens 17. The adjusting knobs 18, 19 are integrally formed on the base body 16 and can, for example, be manufactured from the base body 16 by removal of material. The outside diameter of the adjusting knobs 18, 19 is equal to the outside diameter of the fibers 14. The adjusting knobs 18, 19 are therefore similar to the fibers.

The positioning of the adjusting knobs 18, 19 relative to the lenses 17 is selected such that the cylinder axes of the adjusting knobs 18, 19 lie in a plane with the optical axes of the lenses 17. When the V-grooves 13, 13′ of the fiber groove array 20 have the same mutual spacing, the spacing a of the cylinder axes of the adjusting knobs 18, 19 from the optical axes of the neighboring lenses correspond to a multiple of the spacing b between the optical axes of two neighboring lenses (FIG. 2). If, by contrast, specific V-grooves that lie outside the periodic arrangement of the remaining V-grooves 13, 13′ are provided for the adjustment, the lateral spacing of the adjusting knobs 18, 19 from the lenses 17 can also turn out otherwise. In any case, the adjusting knobs 18, 19 are positioned on the base body 16 such that the optical axes of the optical fibers lying in the V-grooves 13, 13′ align with the optical axes of the assigned lenses when the lens array 15 with its adjusting knobs 18, 19 are inserted into the V-grooves provided therefor.

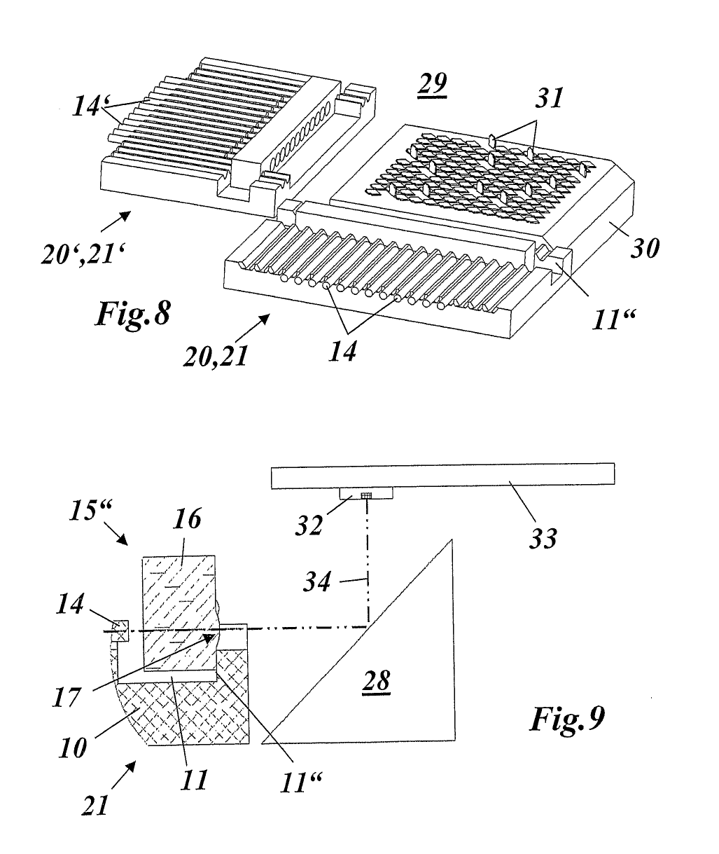

So that the lens array 15 with the fiber groove array 20 can be reliably connected in the adjusted position, there is provided in the substrate 10 of the fiber groove array 20 a transverse groove 11 that runs transverse to the V-grooves 13, 13′ and is mounted at the longitudinal sides by perpendicular sidewalls 11′, 11″ (FIGS. 8, 9). The transverse groove 11 “cuts up” the outer V-grooves into two sections which are provided with the reference symbols 13 and 13′. The sections provided with the reference symbols 13′ are used to hold the adjusting knobs 18, 19 when—as indicated in the case of the fiber-lens array 21 in FIG. 3—the lens array with the lenses 17 is inserted into the transverse groove 11 on the side averted from the fiber 14 (FIG. 3 shows the analogous arrangement of the lens array 15″ from FIG. 5). The sidewall 11″ of the transverse groove 11 in this case serves in an axial direction as a stop for the lens array 15, 15′ or 15″. The depth of the transverse groove 11 is dimensioned such that the lens array can be adjusted without being mounted on the base of the transverse groove 11. In order to enable the light to emerge unhindered from the lenses 17 and leave the fiber-lens array 21 without being disturbed or, conversely, to enter the lenses 17 and fibers 14, the cutout 12 in the substrate 10 which extends in a transverse direction over the row of lenses 17 is provided at the height of the lenses 17 of the lens array 15, 15′, 15″ used.

In another preferred refinement of the lens array 15′ in accordance with FIG. 4, instead of the integrally formed adjusting knobs adjusting fiber sections or adjusting wire sections 22, 23 are provided as adjusting means at a comparable position on the base body 16. The adjusting fiber sections or adjusting wire sections 22, 23 have the same outside diameter as the fibers 14 and are therefore, in turn, similar to the fibers. They are plugged through corresponding bores in the base body 16 and project from the base body 16 on both sides. If the lens array 15′ from FIG. 4 is extended into the transverse groove 11 in the fiber groove array 20 in the way illustrated in FIG. 3, the adjusting fiber sections or adjusting wire sections 22, 23 lie with the projecting ends in the V-grooves 13, 13′ on both sides of the transverse groove 11 such that the lens array 15′ is positioned very stably in the adjusted state. The adjusting fiber sections or adjusting wire sections 22, 23 can in this case be sections of an optical glass fiber or a metal wire of corresponding thickness.

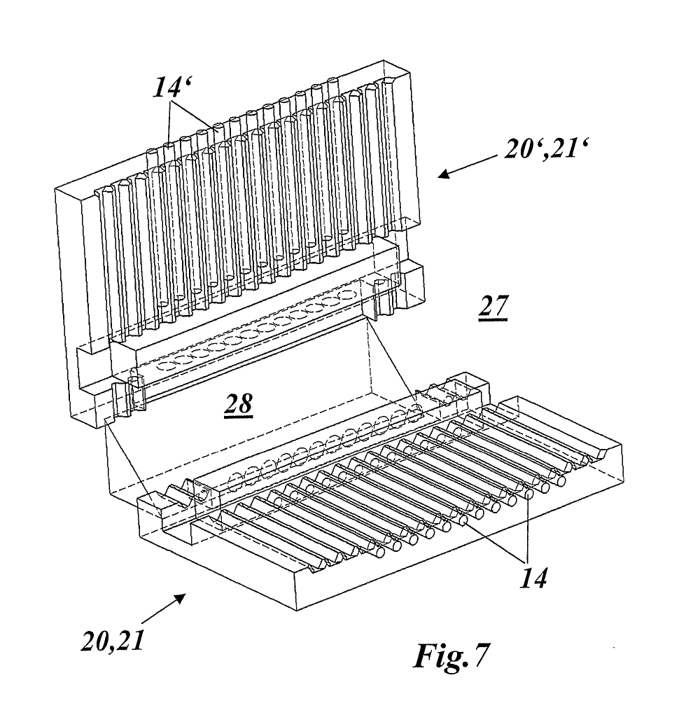

A further preferred type of adjusting means is illustrated in FIGS. 5 and 6. What is involved here is a lens array 15″ with adjusting lenses 24, 25 and/or adjusting marks 26. In a way similar to the actual lenses 17, the adjusting lenses or adjusting marks project only a little over the lateral surface of the base body 16. Their lateral dimensions are tuned to the cross sectional form of the V-grooves 13, 13′ such that they can be used optically and mechanically for the adjustment. In the case of the optical adjustment, monitoring is carried out (for example, under the microscope with the directional view along the V-grooves) as to when the adjusting lenses or adjusting marks assume a specific position relative the V-groove.

This is the case with the adjusting lenses 24, 25 when the outer contour of the adjusting lenses 24, 25 fit exactly into the V-grooves 13, 13′ like a fiber 14. However, an active optical adjustment would also be conceivable. Use would be made to this end of a focusing adjusting lens such that light would be coupled into a glass fiber from a glass fiber of the fiber groove array via the adjusting lens, and the transmission would then be optimized or directly evaluated by a detector arranged downstream of the adjusting lens. In the case of the mechanical adjustment, the raised part of the adjusting lenses or adjusting marks is “set down” in the V-grooves 13′ in a way similar to a fiber stub (see FIG. 6). If the adjusting lenses 24, 25 are round, their outside diameter is preferably equal to the outside diameter of the fibers 14. If the adjusting marks 26 are triangular, they correspond in shape and dimensions to the cross section of the V-grooves 13, 13′ as is illustrated in FIG. 6. Another type of optical adjustment by means of the adjusting lenses 24, 25 can consist in adjusting the adjusting lenses 24, 25 to a light beam that is coupled through or into an optical fiber 14 lying in the corresponding V-groove 13, 13′.

A fiber-lens arrangement 21 such as illustrated in FIG. 3 by way of example can now be used in the most varied applications. In the application for example shown in FIG. 7, an optical 90° deflecting arrangement 27 is implemented in the case of which light is deflected between the fibers 14 of a first fiber groove array 20 in a first fiber-lens arrangement 21 and the fibers 14′ of a second fiber groove array 20′ in a second fiber-lens arrangement 21′ by means of a deflection element 28, for example in the form of a mirror. Each of the two fiber-lens arrangements 21, 21′ in this case has the structure illustrated in FIG. 3, having a substrate 10 with V-grooves 13, 13′ and a lens array 15 and/or 15′ or 15″ inserted in adjusting fashion into a transverse groove 11.

In accordance with FIG. 8, a further application is a switchover arrangement 29 in the case of which two fiber-lens arrangements 21, 21′ with two fiber groove arrays 20, 20′ and corresponding fibers 14, 14′ are arranged, lying in a common plane, at a right angle to one another, and light can be guided to and fro by means of a switchover device 30 between selected pairs of first and second fibers 14 and 14′, respectively. The switchover device 30 can in this case be designed, for example, as a micro-optic switchover device (MEMS or MicroElectroMechanical System optical switch). If an optical coupling is to be produced between one of the n first fibers 14 and one of the m second fibers 14′, the corresponding mirror on the (n×m) matrix of controllable mirrors 31 in the switchover device 30 is driven as appropriate.

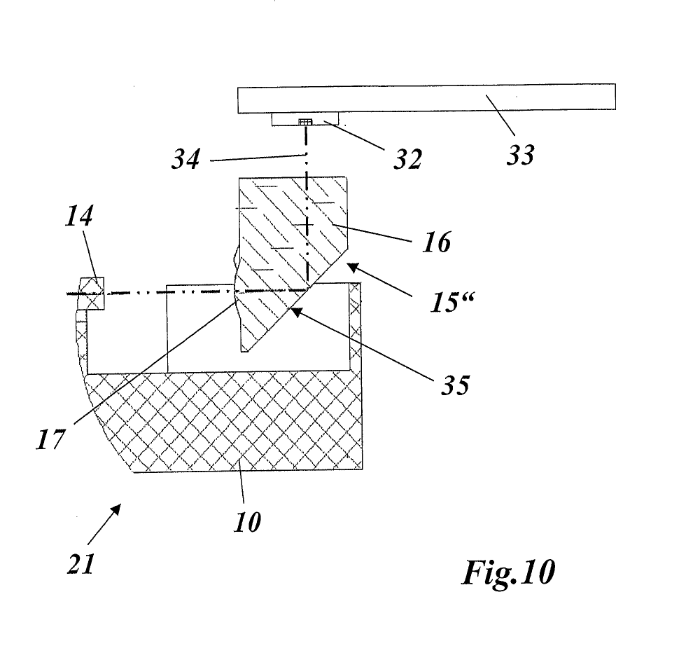

A fiber-lens arrangement according to the invention can, however, also be used for the coupling of fibers 14 to optical components (optotransmitters such as laser diodes, VCSELs (Vertical Cavity Surface Emitting Laser) or the like, or optoreceivers such as phototransistors or the like). FIG. 9 shows an arrangement in which a light beam 34 from the fibers 14 of a fiber-lens arrangement 21 is expanded and parallelized in an adjusted lens array 15″ bearing against the sidewall 11″ of the transverse groove 11 and then is deflected via a deflection element (mirror) 28 into an active component 32 arranged on a carrier substrate 33, or vice versa. A comparable application is reproduced in FIG. 10, the 90° deflection being performed here directly by total internal reflection at a 45° reflecting surface formed and integrated in the base body 16 of the lens array 15″.

The fiber-lens arrangement in accordance with the invention and with the self-adjusting lens array in the unipartite V-groove substrate can be used in general to implement expanding, optically parallel beams. As described in part above, the latter can be applied in micro-optic switchover devices (MEMS switch, OCX or Optical Cross Exchange), in optical 90° deflectors, in wavelength demultiplexers (λ filters or gratings in the beam), in industrial plug-in connectors, and in optical attenuators. Furthermore, the system can be used to focus the beam onto active components (VCSELs photodiodes etc.), or vice versa. The active components can in this case include similar integrated adjusting structures that lock in the same V-grooves 13, 13′ as the microlens arrays 15, 15′, 15″ and the optical fibers 14. In particular, the fiber groove array 20 can be part of a plug-in connector system in the case of which the fibers 14 are introduced removably into the V-grooves 13, 13′ of the substrate 10 in the plug-in operation.

### LIST OF REFERENCE NUMERALS

10 Substrate
11 Transverse groove
11′, 11″ Sidewall (transverse groove)
12 Cutout
13, 13′ V-groove
14, 14′ Optical fiber (light guide fiber)
15, 15′, 15″ Lens array
16 Base body
17 Lens
18, 19 Adjusting knob
20, 20° Fiber groove array
21, 21° Fiber-lens arrangement
22, 23 Adjusting fiber section or adjusting wire section
24, 25 Adjusting lens
26 Adjusting mark
27 Deflecting arrangement
28 Deflection element (for example mirror)
29 Switchover arrangement
30 Micro-optic switchover device (for example MEMS or OCX)
31 Controllable mirror
32 Active component (for example VCSEL)
33 Carrier substrate
34 Light beam (beam path)
35 Reflecting surface

1. A fiber-lens arrangement comprising a fiber groove array with a substrate which has a plurality of parallel running, similar V-grooves that are arranged next to one another and spaced apart from one another and serve for holding and aligning the end sections of a plurality of optical fibers, and a separate lens array which is tuned to the fiber groove array and has in a common base body a number of lenses whose arrangement in the base body corresponds to the arrangement of the optical fibers, lying in the V-grooves of the fiber groove array, on the substrate, wherein the separate adjusting means that cooperate with the V-grooves of the fiber groove array are provided on the lens array for optically aligning the lens array with the fiber groove array.

2. The fiber-lens arrangement as claimed in claim 1, wherein said adjusting means are arranged on the base body of the lens array.

3. The fiber-lens arrangement as claimed in claim 2, wherein said lenses of the lens array are arranged in a linear row next to one another, and in that the adjusting means are arranged outside and in the continuation of the row of lenses.

4. The fiber-lens arrangement as claimed in claim 3, wherein said adjusting means are arranged on both sides of the row of lenses.

5. The fiber-lens arrangement as claimed in claim 1, wherein said adjusting means comprise outwardly projecting, cylindrical adjusting knobs that are integrally formed on the base body and with the aid of which the lens array is inserted into selected V-grooves of the fiber groove array in order to adjust with reference to the fiber groove array.

6. The fiber-lens arrangement as claimed in claim 5, wherein said adjusting knobs have the same outside diameter as the optical fibers.

7. The fiber-lens arrangement as claimed in claim 1, wherein said adjusting means comprise outwardly projecting adjusting fiber sections or adjusting wire sections which have been inserted into the base body and with the aid of which the lens array is inserted into selected V-grooves of the fiber groove array in order to adjust with reference to the fiber groove array.

8. The fiber-lens arrangement as claimed in claim 7, wherein said adjusting fiber sections or adjusting wire sections project outward on opposite sides of the base body, and in that they have the same outside diameter as the optical fibers.

9. The fiber-lens arrangement as claimed in claim 1, wherein said adjusting means comprise adjusting lenses and/or adjusting marks which are attached to or to be formed on the base body and with the aid of which the lens array is aligned with selected V-grooves of the fiber groove array in order to adjust with reference to the fiber groove array.

10. The fiber-lens arrangement as claimed in claim 1, wherein said fiber groove array has a transverse groove that runs transversely to the V-grooves and holds the lens array .

11. The fiber-lens arrangement as claimed in claim 10, wherein said at least some of the V-grooves run on both sides of the transverse groove, and in that the V-grooves running on both sides of the transverse groove are used to adjust the fiber groove array.

12. The fiber-lens arrangement as claimed in claim 10, wherein said transverse groove is bounded on the longitudinal sides by vertical side walls, and in that the lens array with the base body bears against one of the sidewalls of the transverse groove.

13. A lens array for a fiber-lens arrangement as claimed in claim 1, comprising a bar-shaped base body in which a plurality of lenses are arranged in a linear row, wherein provided on the lens array are separate adjusting means that cooperate with the V-grooves, designed for holding the optical fibers, of the fiber groove array.

14. The lens array as claimed in claim 13, wherein said adjusting means are arranged on the base body of the lens array.

15. The lens array as claimed in claim 14, wherein said adjusting means are arranged outside and in the continuation of the row of the lenses.

16. The lens array as claimed in claim 15, wherein said adjusting means are arranged on both sides of the row of lenses.

17. The lens array as claimed in claim 13, wherein said adjusting means comprise outwardly projecting, cylindrical adjusting knobs integrally formed on the base body.

18. The lens array as claimed in claim 17, wherein said adjusting knobs have the same outside diameter as the optical fibers.

19. The lens array as claimed in claim 13, wherein said adjusting means comprise outwardly projecting adjusting fiber sections or adjusting wire sections which have been inserted into the base body.

20. The lens array as claimed in claim 19, wherein said adjusting fiber sections or adjusting wire sections project outward on opposite sides of the base body, and in that they have the same outside diameter as the optical fibers.

21. The lens array as claimed in claim 13, wherein said adjusting means are attached to or to be formed on the base body and with the aid of which the lens array is aligned with selected V-grooves of the fiber groove array in order to adjust with reference to the fiber groove array.

22. The lens array as claimed in claim 13, wherein devices for deflecting the light beams passing through the lenses are provided on the base body.

23. The lens array as claimed in claim 22, wherein said base body is made from an optically transparent material, and in that the deflecting device is a reflecting surface formed on the base body.

24. Use of the fiber-lens arrangement as claimed in claim 1 in a deflecting arrangement in which light from a first fiber groove array is deflected by a deflection element into a second fiber groove array.

25. Use of the fiber-lens arrangement as claimed in claim 1 in a switchover arrangement in which light is optionally switched over via a switchover device from fibers of a first fiber groove array into fibers of a second fiber groove array.

26. The use of the fiber-lens arrangement as claimed in claim 1 for the purpose of optically coupling the fibers of a fiber groove array to active optical components.

27. The fiber-lens arrangement as claimed in claim 1, wherein the number of lenses in the common base body corresponds to the number of optical fibers.

28. The fiber-lens arrangement as claimed in claim 1, wherein the lens is aligned with the selected V-grooves mechanically and/or optically.

29. The lens array as claimed in claim 21, wherein the adjusting means may be comprised of one or both of adjusting lenses and adjusting marks which are attached to or to be formed on the base body.

30. The lens array as claimed in claim 21, wherein the lens array is aligned with the selected V-grooves either mechanically and/or optically.

31. The lens array as claimed in claim 23, wherein the optically transparent material is glass.
